(19) United States
(12) Patent Application Publication
(10) Pub. No.: US 2012/0246508 A1
(43) Pub. Date: Sep. 27, 2012

(54) METHOD AND SYSTEM FOR CONTINUOUSLY PROVIDING A HIGH PRECISION SYSTEM CLOCK

(75) Inventors: Eberhard ENGLER, Boeblingen (DE); Guenter GERWIG, Boeblingen (DE); Frank LEHNERT, Boeblingen (DE); Klaus MEISSNER, Boeblingen (DE); Joachim von BUTTLAR, Boeblingen (DE)

(73) Assignee: INTERNATIONAL BUSINESS MACHINES CORPORATION, Armonk, NY (US)

(21) Appl. No.: 13/397,178

(22) Filed: Feb. 15, 2012

(30) Foreign Application Priority Data
Mar. 21, 2011 (EP) 11158972.7

(51) Int. Cl. G06F 11/07

(52) U.S. Cl. 714/3; 714/E11.021

(57) ABSTRACT

A method is presented for continuously providing a high precision system clock associated with a processing core, wherein the system clock includes a host clock register that is incremented via a high precision oscillator, the method includes: providing a firmware clock register, incrementing the firmware clock register based on the host clock register being incremented, monitoring for failures of the host clock register, and during a failure of the host clock register continuously incrementing the firmware clock register by means of timing signals of the processing core, and upon receipt of a request to provide a clock value, providing the content of the host clock register if no failure was detected, or if failure was detected, providing the content of the firmware clock register.

### PRIOR FOREIGN APPLICATION

This application claims priority from European patent application number EP11158972.7, filed Mar. 21, 2011, which is hereby incorporated herein by reference in its entirety.

### FIELD OF THE INVENTION

The present invention relates to a method for continuously providing a high precision system clock associated with a processing core, wherein the system clock comprises a host clock register being incremented by means of a high precision oscillator.

The present invention further relates to a processing unit having a processing core and a clock module for providing a high precision system clock, the clock module comprising a host clock register being updated by a high precision oscillator. The present invention also relates to a computer-readable medium and a computer program product for executing the above method.

### BACKGROUND

In modern computer systems, there is a need to have fast and continuous access to a high precision system clock, which is in some implementations also referred to as “time of day” (TOD). The high precision system clock is used for various purposes inside a computer, especially on a firmware level. These purposes comprise billing, which refers to monitoring the use of computer resources by different accounts, supervising operations, or scheduling of tasks. The high precision system clock can also be used by different processes and applications, including virtual machines and different guest processes. Accordingly, it is important to have the system clock permanently available.

The high precision system clock usually uses a register, also called the host clock register or system clock register, which contains the current time. The host clock register is continuously incremented by means of a high precision oscillator, which typically has an oscillator frequency of 16 MHz and is a standard component to provide high precision timing signals. The smallest time unit measurable by the high precision system clock is the time period of one oscillation, which is in the case of the aforementioned 16 MHz oscillator a time of 62.5 ns. It is of course also possible that the system clock is continuously decremented without any change in the general behavior.

The high precision system clock can have time periods of failure, e.g. due to a set-up, changes in time zones, the execution of system clock related commands, especially on firmware level, or even missing oscillator pulses, a switch between the used oscillator or hardware failures of the processor core the system clock is associated too. These problems typically refer to failures having a duration of typically not more than 20 ms. This is acceptable for applications running on top of an operating system, including those running in a virtual machine, since the situations of a system clock failure are rare. Nevertheless, firmware needs to supervise operations and do accounting for runtime and scheduling even in these situations. Accordingly, there exists a problem especially for firmware, when no fully synchronized and valid high precision system clock is available.

Although the access to an external clock is still possible in most cases, this usually has a long latency leading to bad performance and providing an imprecise time base. Especially in parallel computing the increasing latency to access the external clock makes the problem worse. Also different estimation techniques have been used to solve this problem and to provide high precision clock values, when a failure of the system clock occurs. Nevertheless, none of these approaches has provided a sufficiently reliable solution for the use for the aforementioned purposes. With increasing multiprocessor systems, the complexity of firmware has also increased, making this problem even worse.

### BRIEF SUMMARY

Provided herein, in one aspect, is a method for providing a high precision system clock associated with a processing core, wherein the system clock comprises a host clock register incremented by means of a high precision oscillator. The method includes: providing a firmware clock register, incrementing the firmware clock register when the host clock register is incremented, monitoring for failures of the host clock register, and during a failure of the host clock register continuously incrementing the firmware clock register by means of timing signals of the processing core, and upon reception of a request to provide a clock value, providing the content of the host clock register if no failure is detected, and if failure is detected, providing the content of the firmware clock register.

Computer systems and computer program products relating to one or more aspects of the present invention are also described and claimed herein.

Additional features and advantages are realized through the techniques of one or more aspects of the present invention. Other embodiments and aspects of the invention are described in detail herein, and are considered a part of the claimed invention.

### BRIEF DESCRIPTION OF THE SEVERAL VIEWS OF THE DRAWINGS

Embodiments of the invention are illustrated in the accompanied figures. These embodiments are merely exemplary, i.e. they are not intended to limit the content and scope of the appended claims.

FIG. 1 shows a schematic overview of a processing unit according to the present invention, in accordance with one or more aspects of the present invention; and

FIG. 2 shows a flowchart of a system clock handling of the processing unit according to FIG. 1.

### DETAILED DESCRIPTION OF EXEMPLARY EMBODIMENTS

It is an object of the present invention to provide a method, a system, a computer program product and a computer-readable medium for providing a precision system clock, which has a high availability combined with high precision.

This object is achieved by the independent claims. Advantageous embodiments are detailed in the dependent claims.

Accordingly, this object is achieved by a method for continuously providing a high precision system clock associated with a processing core, wherein the system clock comprises a host clock register being incremented by means of a high precision oscillator, the method comprising: providing a firmware clock register, incrementing the firmware clock register every time the host clock register is incremented, monitoring for failures of the host clock register, and during a failure of the host clock register continuously incrementing the firmware clock register by means of timing signals of the processing core, and upon reception of a request to provide a clock value, providing the content of the host clock register if no failure is detected and if failure is detected, providing the content of the firmware clock register.

A corresponding processing unit has a processing core and a clock module for providing a high precision system clock, the clock module comprising a host clock register being updated by a high precision oscillator and a firmware clock register, whereby the processing unit is adapted to perform the above method.

The present invention provides, apart from the system clock, a second, firmware-based clock, which is continuously updated based on the host clock, when available, and by means of timing signals of the processing core, when the system or host clock is not available. Hence a second clock, the firmware clock, is provided, which is independent from failures if the system clock. In cases the system clock is available, requested clock values are provided based on the system clock, otherwise based on the firmware clock. Host clock or system clock refers in this case to a clock based on the host clock register, whereas the firmware clock refers to a clock based on the firmware clock register. Although it is mentioned that the system clock is continuously incremented, an implementation of a continuously decremented system clock is also possible without any general impact on the teaching as provided herein. Accordingly, a decrementing clock is also covered by the disclosure of this application.

According to a modified embodiment of the present invention, the monitoring for failures of the host clock register comprises verifying every processor core cycle if the host clock register is valid. This allows an immediate reaction on failures of the host clock register, so that incrementing the firmware clock register based on the timing signals from the processing core can be started immediately. Continuously monitoring the host clock register is further important, because every processor core cycle a clock value can be requested by any task, e.g. firmware or application, so that it is important to always know the status of the host clock register when the request is received.

In one embodiment of the present invention, providing the content of the host clock register comprises comparing the content of the host clock register to the content of the firmware clock register and providing the content of the host clock register when the content of the host clock register is at least equal to the content of the firmware clock register. As already mentioned, the system clock is a continuous clock and accordingly does not step back. A clock value being smaller than a previously provided clock value, also referred to as invalid clock value, shall never be provided. Since the time base of the system clock and the firmware clock are different and especially the firmware clock is based on timing signals from the processing core having a lower precision than the high precision oscillator, there is a possibility that this case might occur. In this case, comparing the host clock register and the firmware clock register allows the system to determine the invalid clock values and to avoid providing them.

An embodiment of the present invention further comprises waiting until the content of the host clock register is at least equal to the content of the firmware clock register in case the content of the host clock register is smaller than the content of the firmware clock register. Instead of returning an undefined value, or an error message, after a wait time a valid clock value can be provided. Due to the small time periods of typical failures of the system clock, it is assumed that the deviation between the system clock and the firmware clock is rather small, so that the wait time will be rather small as well. Accordingly, waiting until the system clock reaches the firmware clock is a suitable means for solving this conflict.

According to a modified embodiment of the present invention, incrementing the firmware clock register by means of timing signals of the processing core comprises incrementing a counter every processor core cycle and incrementing the firmware clock register when the counter reaches a pre-defined maximum count. The value of the counter may be reset every time the maximum count is reached to enable continuously incrementing the firmware clock register. Incrementing the counter can be realized, e.g., by means of pulses from a core oscillator of the processing core. Although the accuracy of the core oscillator is below the accuracy of the high precision oscillator, it is still sufficient as time base for the firmware clock. Since the supposed periods of failure of the system clock are in the range of typically up to 20 ms. The pre-defined maximum count can also be referred to as a frequency divider setting and can by way of example be calculated as given below.

In today's implementations, processing cores are running at frequencies of up to 5 GHz. Since the frequency of the core oscillator is much higher than the frequency of the high precision oscillator, the firmware clock register will only be updated after a specified number of pulses from the core oscillator have been generated. The counter can be implemented in the clock module, so that the pulses of the core oscillator represent the timing signals from the processing core. Alternatively, the counter can be implemented in the processing core, so that a timing signal to the clock module can be generated every time the specified number of pulses from the core oscillator has been determined by the processing core. The frequency divider setting can be calculating specifying the number of pulses of the core oscillator required to increment the firmware clock register. The calculation can by way of example be done the following way:

$$frequency divider setting = round ( ( \frac{core frequency}{oscillator frequency} ) + 1 ) .$$

Applying the aforementioned frequencies for the core oscillator (core) having a frequency of 5 GHz and the high precision oscillator (oscillator) having a frequency of 16 MHz, the frequency divider setting is calculated to be

frequency divider setting=round((5000:16)+1)=314.

Some processing cores are provided with a variable core frequency. In this case the maximum core frequency is taken as core frequency for this calculation to avoid that the firmware clock is incremented too frequently, which would lead to discontinuities when switching back to providing clock values from the system clock register. The probability for the firmware clock having a bigger value than the host clock can be further reduced by adding an additional margin to the above calculated frequency divider setting. When dealing with processing cores having a variable core frequency, it is also possible to monitor the current core frequency and to update the maximum count based on the current frequency.

According to one embodiment of the present invention, providing the content of the host clock register or the firmware clock register comprises copying the respective register value into a target register. To have rapid access to the time value, copying the content of the respective register is a quick way. On firmware level, means for directly accessing the registers are typically available, so that the implementation of this feature can easily be realized.

In a modified embodiment of the present invention, providing the content of the firmware clock register comprises adding an offset to the content of the firmware clock register. The offset allows continuously maintaining the firmware clock at an internal level, even with changes in time zones, changes from summer to winter time or the other way around, or others similar occasions require a discontinuity of the system clock. In this case, the firmware clock register can be continuously updated as described herein, only the offset will be added to the firmware clock register when providing the firmware clock. Accordingly, on firmware clock register level, internal discontinuities are avoided.

In one implementation of the processing unit, the processing core can be provided integral with the clock module depending on the desired integration level of the processing unit. It is also possible to provide a processing unit having multiple processing cores, each having a clock module, or a processing unit having multiple processing cores and a single clock module.

The invention can also be achieved by a computer-readable medium such as a storage device, a floppy disk, CD, DVD, Blue Ray disk, or a random access memory (RAM), containing a set of instruction that causes a computer to perform one or more of the methods as specified above. The invention can be further achieved by a computer program product comprising a computer usable medium including computer usable program code, wherein the computer usable program code is adopted to execute the method as described above.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

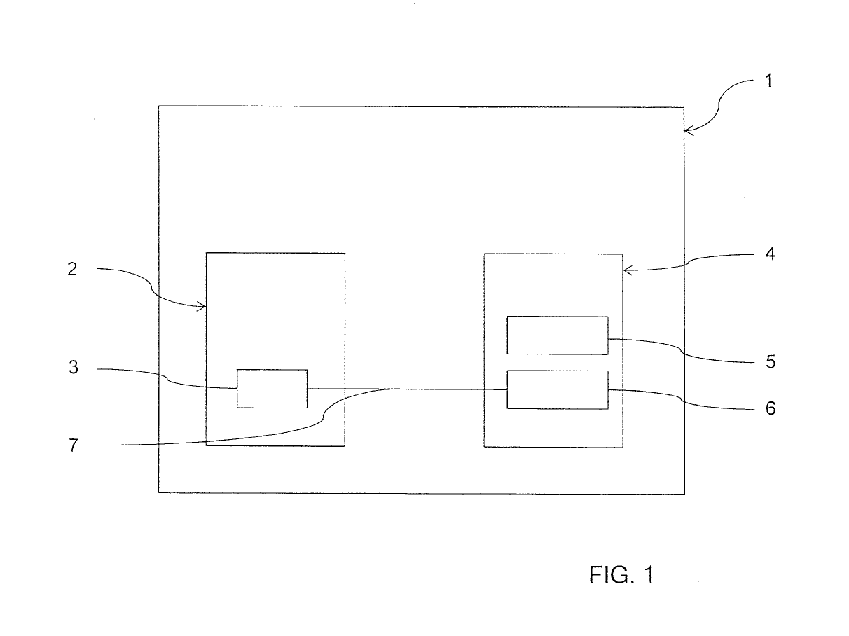

Referring now to FIG. 1, a processing unit 1 for providing a high precision system clock can be seen. The processing unit 1 comprises a single processing core 2 having a core oscillator 3. It is assumed for this embodiment of the present invention, that the frequency of the core oscillator 3 is fixed. The processing unit 1 further comprises a clock module 4 with a host clock register 5 and a firmware clock register 6.

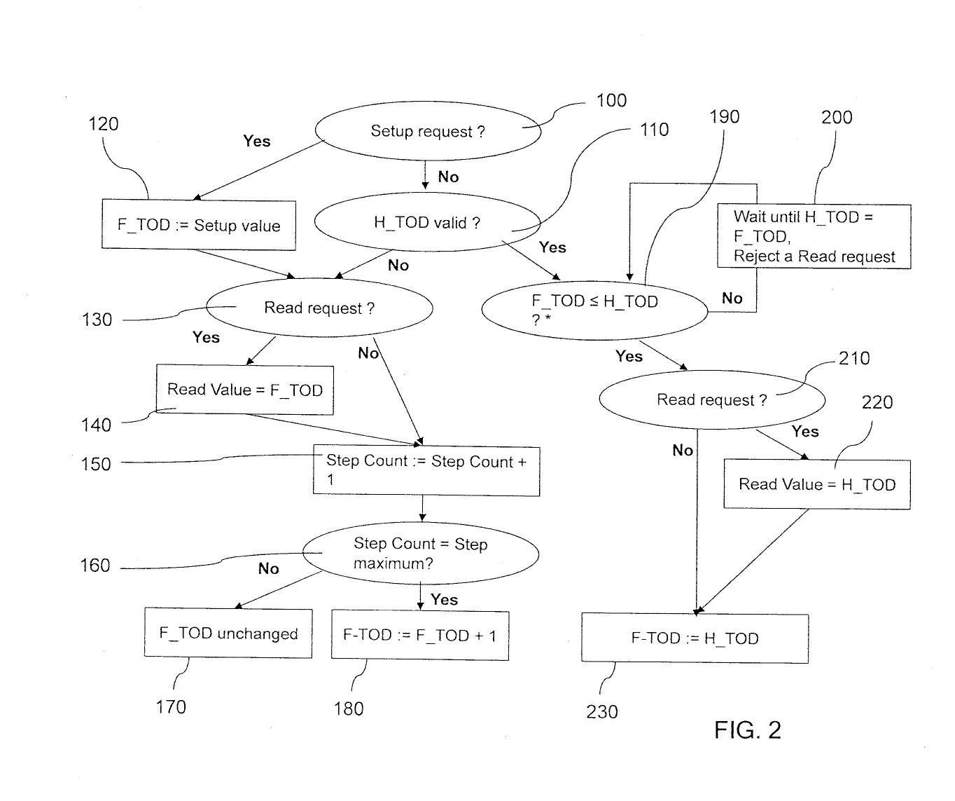

The operation of the processing unit 1 according to the present invention will now be described with respect to FIG. 2. The clock module 4 is connected to a high precision oscillator, which is not shown in the figures, and via a connection 7 to the core oscillator 3. The high precision oscillator can be either provided outside the processing unit 1, inside the processing unit 1 or even inside the clock module 4. By way of example, the processing unit 1 comprises just one processing core 2. Nevertheless, a processing unit 1 in a different embodiment of the present invention can also comprise multiple processing cores 2 and one or multiple clock modules 4. In case of multiple clock modules 4, the high precision oscillator can be provided individually for each clock module 4 or commonly for all clock modules 4.

Now referring to FIG. 2, a flowchart for maintaining continuous high precision system clock is shown. The flowchart shown in FIG. 2 is executed every processing cycle of the processor core 2 of the processing unit 1. The high precision system clock is also referred to as time of day (TOD), where a host TOD refers to the system clock based on the host clock register 5 and the firmware TOD refers to a firmware clock based on the firmware clock register 6. Alternatively, the firmware TOD is also referred to as firmware clock and the host TOD is also referred to as host or system clock. In FIG. 2, the firmware TOD is denoted F_TOD, and the host TOD is denoted H_TOD.

Step 100 is verified if a setup request is received. If no setup request is received, the method continuous with step 110, otherwise it continues with step 120.

Step 110 is verified if the host time of day is valid. This is monitored by the firmware running on the processing unit 1, or in case of a processing unit 1 having a common high precision oscillator and multiple clock modules 4, it can also be monitored by a common firmware providing this information to multiple processor cores 2. If there is an indication that the host TOD is valid, the method continues with step 190, otherwise it continues with step 130.

According to step 120, the firmware clock is setup. The content of the firmware clock register 5 is set to a given value, denoted as setup value. The method then continues with step 130.

Step 130 determines whether a read request for a high precision system clock is received. The request for a setup of the firmware clock register automatically assumes that the system clock is not valid. Accordingly, in both cases the further handling only refers to the firmware clock register 6. If a read request is received, the method continues with step 140. Otherwise it continues with step 150.

According to step 140, the firmware clock register 6 is read to provide a high precision system clock value. The reading of the clock value can be performed by merely copying the contents of the firmware clock register 6 to a desired register in the memory of the processing unit 1, or to any other suitable location. The method then continues with step 150.

In step 150 a counter, also called step count, is incremented as basis for incrementing the firmware clock register 6. The counter is incremented every cycle of the processing core 2, since the flowchart is executed with every cycle of the processing core 2.

In step 160, the current step count is compared to a step maximum. The step maximum is a pre-calculated value depending on the frequency relation between high precision oscillator and the processing core oscillator 3, also referred to as frequency divider setting. Assuming the core oscillator having a frequency of 5 GHz and the high precision oscillator having a frequency of 16 MHz, the step maximum is calculated to be:

step maximum=round((5000:16)+1)=314.

If the step maximum has not been reached, in step 170 the firmware clock register 6 remains unchanged and the method finishes for the current cycle of the processing core 2. If the step count has reached the step maximum, the firmware clock register 6 is incremented by one in step 180. For this branch, this is the last execution step of the flowchart for this cycle of the processing core 2.

According to step 190, processing determines whether the firmware clock register 5 is smaller than or equal to the host clock register 5. If not, the method continues with step 200, otherwise with step 210.

A waiting time is applied in step 200. During the waiting time, the read request is rejected. After the waiting time, the method continues with step 190. Step 200 therefore represents a local waiting until the condition of step 190 is fulfilled.

In step 210 is, similar to step 130, verified, if a read request for a high precision system clock is received. If a request is received the method continues with step 220, otherwise it proceeds with step 230.

In step 220, the content of the host clock register 5 is assigned to a variable called read value. A typical operation for reading the host clock register 5 is merely copying the content of the host clock register 5 to another register of the processing unit 1 or elsewhere in the IT system. The method then continues at step 230.

In step 230, the content of the firmware clock register 6 is set to the value of the host clock register 5. Thereby, it is assured that the firmware clock register 6 is updated when the host clock register 5 is updated, so that the content of the two registers 5, 6 is always identical while there is no failure of the host clock register 5 detected. Accordingly, an update can be performed every cycle of the processing core 2.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been illustrated and described in detail in the drawings and fore-going description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

What is claimed is:

1. A method for providing a high precision system clock associated with a processing core, wherein the system clock comprises a host clock register incremented by means of a high precision oscillator, the method comprising:
providing a firmware clock register;
incrementing the firmware clock register when the host clock register is incremented;
monitoring for failures of the host clock register, and during a failure of the host clock register, continuously incrementing the firmware clock register by means of timing signals of the processing core; and
upon reception of a request to provide a clock value, providing the content of the host clock register if no failure is detected, and if failure is detected, providing the content of the firmware clock register.

2. The method according to claim 1, wherein the monitoring for failures of the host clock register comprises verifying every processor core cycle if the host clock register is valid.

3. The method according to claim 1, wherein the providing the content of the host clock register comprises comparing the content of the host clock register to the content of the firmware clock register and providing the content of the host clock register based on the content of the host clock register being at least equal to the content of the firmware clock register.

4. The method according to claim 3, further comprising waiting until the content of the host clock register is at least equal to the content of the firmware clock register in case the content of the host clock register is smaller than the content of the firmware clock register.

5. The method according to claim 1, wherein incrementing the firmware clock register by means of timing signals of the processing core comprises incrementing a counter every processor core cycle and incrementing the firmware clock register when the counter reaches a pre-defined maximum count.

6. The method according to claim 1, wherein the providing the content of the host clock register or the firmware clock register comprises copying the respective register value into a target register.

7. The method according to claim 1, wherein the providing the content of the firmware clock register comprises adding an offset to the content of the firmware clock register.

8. A computer system for providing a high precision system clock associated with a processing core, wherein the system clock comprises a host clock register incremented by means of a high precision oscillator, the computer system comprising:
a memory; and
a processor in communications with the memory, wherein the computer system is configured to perform:
providing a firmware clock register;
incrementing the firmware clock register when the host clock register is incremented;
monitoring for failures of the host clock register, and during a failure of the host clock register, continuously incrementing the firmware clock register by means of timing signals of the processing core; and
upon reception of a request to provide a clock value, providing the content of the host clock register if no failure is detected, and if failure is detected, providing the content of the firmware clock register.

9. The computer system of claim 8, wherein the monitoring for failures of the host clock register comprises verifying every processor core cycle if the host clock register is valid.

10. The computer system of claim 8, wherein the providing the content of the host clock register comprises comparing the content of the host clock register to the content of the firmware clock register and providing the content of the host clock register based on the content of the host clock register being at least equal to the content of the firmware clock register.

11. The computer system of claim 10, wherein the computer system is further configured to perform waiting until the content of the host clock register is at least equal to the content of the firmware clock register in case the content of the host clock register is smaller than the content of the firmware clock register.

12. The computer system of claim 8, wherein incrementing the firmware clock register by means of timing signals of the processing core comprises incrementing a counter every processor core cycle and incrementing the firmware clock register when the counter reaches a pre-defined maximum count.

13. The computer system of claim 8, wherein the providing the content of the host clock register or the firmware clock register comprises copying the respective register value into a target register.

14. The computer system of claim 8, wherein the providing the content of the firmware clock register comprises adding an offset to the content of the firmware clock register.

15. A computer program product for providing a high precision system clock associated with a processing core, wherein the system clock comprises a host clock register incremented by means of a high precision oscillator, the computer program product comprising:
a non-transitory storage medium readable by a processor and storing instructions for execution by the processor for performing:
providing a firmware clock register;
incrementing the firmware clock register when the host clock register is incremented;
monitoring for failures of the host clock register, and during a failure of the host clock register, continuously incrementing the firmware clock register by means of timing signals of the processing core; and
upon reception of a request to provide a clock value, providing the content of the host clock register if no failure is detected, and if failure is detected, providing the content of the firmware clock register.

16. The computer program product of claim 15, wherein the monitoring for failures of the host clock register comprises verifying every processor core cycle if the host clock register is valid.

17. The computer program product of claim 15, wherein the providing the content of the host clock register comprises comparing the content of the host clock register to the content of the firmware clock register and providing the content of the host clock register based on the content of the host clock register being at least equal to the content of the firmware clock register.

18. The computer program product of claim 17, further comprising waiting until the content of the host clock register is at least equal to the content of the firmware clock register in case the content of the host clock register is smaller than the content of the firmware clock register.

19. The computer program product of claim 15, wherein incrementing the firmware clock register by means of timing signals of the processing core comprises incrementing a counter every processor core cycle and incrementing the firmware clock register when the counter reaches a pre-defined maximum count.

20. The computer program product of claim 15, wherein the providing the content of the firmware clock register comprises adding an offset to the content of the firmware clock register.
